(19) United States
(12) Patent Application Publication
(10) Pub. No.: US 2025/0348419 A1
(43) Pub. Date: Nov. 13, 2025

(54) METHOD, DEVICE AND COMPUTER PROGRAM PRODUCT FOR TESTING PULL REQUEST

(71) Applicant: Dell Products L.P., Round Rock, TX (US)

(72) Inventors: Xiaojian Wang, Shanghai (CN); Jun Hu, Shanghai (CN); Xiaopeng Wu, Shanghai (CN); Ran Lv, Shanghai (CN); Zhiyang Zhang, Shanghai (CN)

(21) Appl. No.: 18/973,971

(22) Filed: Dec. 9, 2024

(30) Foreign Application Priority Data
May 10, 2024 (CN) 202410578850.3

(51) Int. Cl. G06F 11/3668

(52) U.S. Cl. CPC G06F 11/3688; G06F 11/3684; G06F 11/3692

(57) ABSTRACT

Techniques for testing a pull request involve acquiring a pull request for a software system. Such techniques further involve determining one or more functions involved in the pull request, and determining one or more test cases corresponding to the one or more functions based on a mapping table, wherein the mapping table indicates a correspondence between the functions and the test cases. Such techniques further involve running the one or more test cases to test the pull request. In this way, it is possible to run test cases corresponding to functions involved in a pull request by means of a mapping table indicating the correspondence between the functions and the test cases, and to run these test cases in a targeted manner to determine the pull request, thereby saving time and improving the efficiency and accuracy of the testing.

### CROSS-REFERENCE TO RELATED APPLICATION

This application claims priority to Chinese Patent Application No. CN202410578850.3, on file at the China National Intellectual Property Administration (CNIPA), having a filing date of May 10, 2024, and having “METHOD, DEVICE AND COMPUTER PROGRAM PRODUCT FOR TESTING PULL REQUEST” as a title, the contents and teachings of which are herein incorporated by reference in their entirety.

### TECHNICAL FIELD

The present disclosure relates to the field of computers and, more particularly, to a method, device, and computer program product for testing a pull request.

### BACKGROUND

A pull request, also known as a merge request, is a common collaboration mechanism used in an open source community that can be used for implementing functions such as code development, code review, project document management, bug fixing, and versioning. For example, a pull request allows a developer to make code modifications and developments on his or her own branch, and then initiate a pull request to a maintainer of the original software system to request that his or her code be merged into the master code branch. A pull request contains code changes made by a developer along with relevant descriptive information which can be reviewed and discussed by other developers to decide whether to accept these changes and merge them in, thereby facilitating the development of the same software system by multiple developers at the same time.

In practice, when a developer initiates a pull request, merging the code in the pull request into the master branch may introduce bugs that affect the operation of the software system, and thus the pull request needs to be tested to determine whether it can be merged into the master branch.

### SUMMARY OF THE INVENTION

Embodiments of the present disclosure relate to a method, device, and computer program product for testing a pull request.

According to a first aspect of the present disclosure, a method for testing a pull request is provided.

The method includes: acquiring a pull request for a software system; determining one or more functions involved in the pull request; determining one or more test cases corresponding to the one or more functions based on a mapping table, wherein the mapping table indicates a correspondence between the functions and the test cases; and running the one or more test cases to test the pull request.

According to a second aspect of the present disclosure, an electronic device is provided. The electronic device includes at least one processor and a memory, wherein the memory is coupled to the at least one processor and has instructions stored thereon. The instructions, when executed by the at least one processor, cause the electronic device to perform the following actions: acquiring a pull request for a software system; determining one or more functions involved in the pull request; determining one or more test cases corresponding to the one or more functions based on a mapping table, wherein the mapping table indicates a correspondence between the functions and the test cases; and running the one or more test cases to test the pull request.

According to a third aspect of the present disclosure, a computer program product is provided that is tangibly stored on a non-volatile computer-readable medium and includes machine-executable instructions, the machine-executable instructions, when executed, causing a machine to perform the following: acquiring a pull request for a software system; determining one or more functions involved in the pull request; determining one or more test cases corresponding to the one or more functions based on a mapping table, wherein the mapping table indicates a correspondence between the functions and the test cases; and running the one or more test cases to test the pull request.

It should be understood that the content described in the Summary of the Invention part is neither intended to limit key or essential features of the embodiments of the present disclosure, nor intended to limit the scope of the present disclosure. Other features of the present disclosure will become readily understood from the following descriptions.

### DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1A illustrates a schematic diagram of an example environment in which a method for testing a pull request may be implemented according to multiple embodiments of the present disclosure;

FIG. 1B illustrates a schematic diagram of a pull request according to multiple embodiments of the present disclosure;

FIG. 2 illustrates a flow chart of a method for testing a pull request according to some embodiments of the present disclosure;

FIG. 3 illustrates a flow chart of a method for establishing a mapping table according to some embodiments of the present disclosure;

FIG. 4 illustrates a flow chart of another method for establishing a mapping table according to some embodiments of the present disclosure;

FIG. 5 illustrates a flow chart of a further method for establishing a mapping table according to some embodiments of the present disclosure;

FIG. 6 illustrates a flow chart of a method for testing a pull request according to some embodiments of the present disclosure; and

FIG. 7 illustrates a block diagram of a device that can implement a plurality of embodiments of the present disclosure.

### DETAILED DESCRIPTION

The individual features of the various embodiments, examples, and implementations disclosed within this document can be combined in any desired manner that makes technological sense.

Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

There is a need to test a pull request to determine whether code modifications therein can be merged into a master branch of a software system. However, conventional methods for testing a pull request only run some fixed sanity tests to ensure that there are no obvious bugs or anomalies in the software system, and if a full test of the pull request is desired, the test cases involved in the pull request need to be determined by manually reviewing the code by team members. Testing a pull request may require running of a large number of test cases it involves, or even all the test cases for the software system, thus causing the manual review approach to be time-consuming and labor-intensive, and making it impossible to cover all the test cases involved in that pull request, which will lead to bugs when the code is merged into the software system.

To this end, embodiments of the present disclosure propose a scheme for testing a pull request. In embodiments of the present disclosure, a pull request for a software system is acquired. One or more functions involved in the pull request are determined. One or more test cases corresponding to the one or more functions are determined based on a mapping table, wherein the mapping table indicates a correspondence between the functions and the test cases. The one or more test cases are run to test the pull request.

In this way, it is possible to run test cases corresponding to functions involved in a pull request by means of a mapping table indicating the correspondence between the functions and the test cases, and to run these test cases in a targeted manner to determine the pull request. In this way, the test cases associated with the pull request can be covered without running all the test cases for the software system during the testing of the pull request, thereby saving time, improving the efficiency and accuracy of the testing, and reducing the likelihood of bugs after code merging.

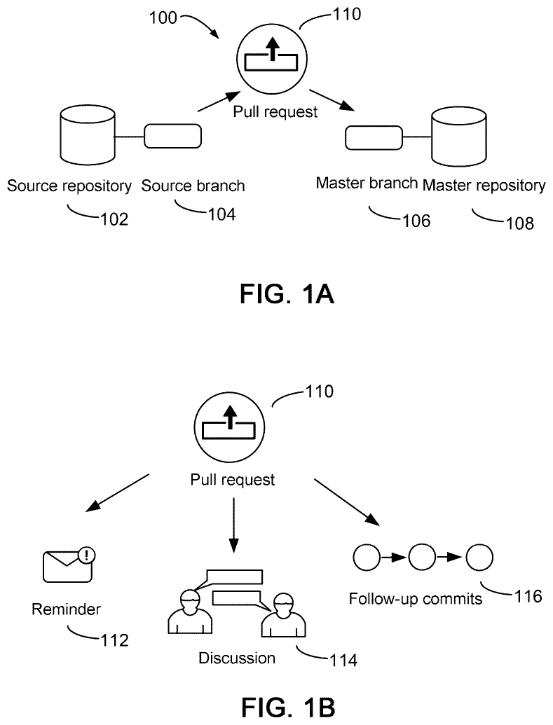

FIG. 1A illustrates a schematic diagram of an example environment 100 in which a method for testing a pull request may be implemented according to multiple embodiments of the present disclosure. As shown in FIG. 1A, the environment 100 may include a source repository 102 and a master/main repository 108, where the source repository 102 is the location where the code is initially created or stored, and the master repository 108 is the location where the core code of the software system is stored. It should be understood that the master repository 108 carries the core code version and the development direction of the project (or software system) and is the central repository where the team primarily collaborates, merges, and manages the code. It should be understood that the repository may be a repository hosted on a public code hosting platform. In some embodiments, the source repository 102 and the master repository 108 may be the same repository. In some embodiments, the source repository 102 and the master repository 108 may be different repositories.

In some embodiments, a developer specifies a development function branch as a source branch 104 in the source repository 102, makes code modifications on the source branch 104, then initiates a pull request 110, and requests via the pull request 110 that the modifications on the source branch 104 be pushed to a specified master branch 106 in the master repository 108. Before merging into the master branch 106, a maintainer of the project or other members of the team may test the pull request 110. In some embodiments, if it is determined that there is no problem with the functionality at the master branch 106, it will be modified and merged into the master branch 106 and stored in the master repository 108. If it is determined that there is a problem with the functionality at the master branch 106, the maintainer may provide feedback in the pull request 110 and display it as a comment to the developer.

FIG. 1B illustrates a schematic diagram of testing a pull request 110 according to multiple embodiments of the present disclosure. As shown in FIG. 1B, the developer may initiate the pull request 110 after the function development is completed. In some embodiments, the pull request 110 may be used to issue a reminder 112 to alert other members of the team to perform a code review so as to determine whether to perform merging into the master branch. In some embodiments, the members of the team may engage in a discussion 114 with each other on the code hosting platform with respect to the pull request 110.

In some embodiments, members of the team may perform follow-up commits 116 with respect to the pull request 110. For example, if there are any problems with the code modifications in the pull request 110, members of the team can provide feedback in the pull request 110 or even push a new commit fine-tuning function. All these follow-up activities can be tracked directly in the pull request 110. As can be seen, the form of the extract request 110 helps to create a smoother work flow, thus eliminating the need for developers to repeatedly reply to emails, which is simple and convenient, and enables a more convenient code collaboration model.

It should be understood that the types and numbers of modules, data transmission processes, arrangements, implementations, and the like shown in FIGS. 1A and 1B are only illustrative, and that the environment 100 can include different numbers and arrangements of models, data transmission processes, a variety of additional elements, and the like.

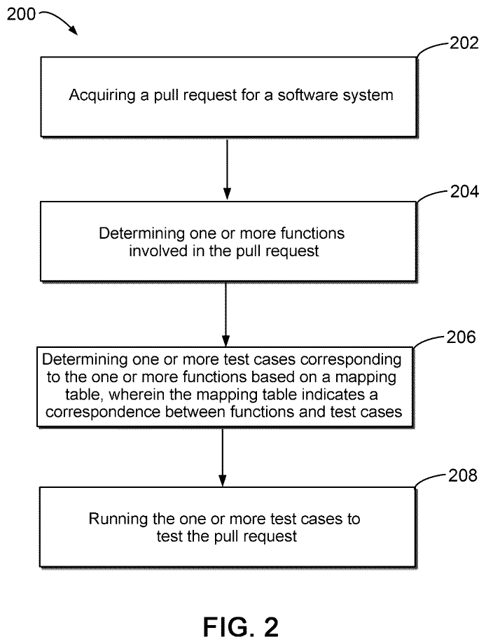

FIG. 2 illustrates a flow chart of a method 200 for testing a pull request according to some embodiments of the present disclosure. To better describe the method 200, it is described herein with reference to the example environment 100 depicted in FIG. 1A.

At 202, a pull request for a software system is acquired. For example, for the environment 100 in FIG. 1A, the pull request 110 for the software system may be acquired from the source branch 104 of the source repository 102. In some embodiments, the pull request 110 may include a code modification for the software system.

At 204, one or more functions involved in the pull request are determined. For example, for the environment 100 of FIG. 1A, one or more functions involved in the modified code in the pull request 110 may be determined. It should be understood that functions are associated with test cases, and for different test cases, corresponding functions may be included.

At 206, one or more test cases corresponding to the one or more functions are determined based on a mapping table, wherein the mapping table indicates a correspondence between the functions and the test cases. At 208, the one or more test cases are run to test the pull request. For example, for the environment 100 in FIG. 1A, the one or more test cases determined in 206 are run to test the pull request 110, so as to determine whether the modified code in the pull request 110 can be merged into the master branch 106 of the master repository 108. For example, it may be determined whether the merging of the modified code in the pull request 110 into the master branch 106 would result in an adverse effect or bugs thereon.

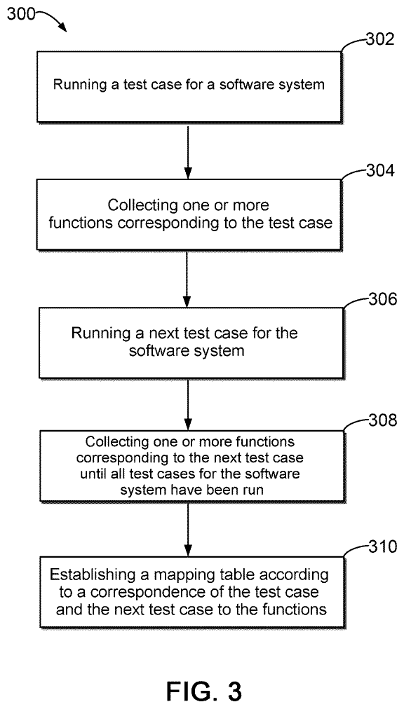

It should be understood that by means of the method 200, it is possible to run the test cases corresponding to the functions involved in a pull request by means of a mapping table indicating the correspondence between the functions and the test cases, and to run these test cases accordingly to determine the pull request, which can save time for testing and can cover the various test cases related to the pull request, thereby improving the efficiency and accuracy of testing and reducing the likelihood of bugs after code merging. It should be understood that the method 200 may also include establishing a mapping table, and a method for establishing a mapping table will be described below in accordance with FIG. 3.

FIG. 3 illustrates a flow chart of a method 300 for establishing a mapping table according to some embodiments of the present disclosure. At 302, a test case for a software system is run, where this test case may also be referred to as a first test case. At 304, one or more functions corresponding to the test case are collected. At 306, a next test case for the software system is run, where this next test case may also be referred to as a second test case. At 308, one or more functions corresponding to the next test case are collected until all test cases for the software system have been run. At 310, a mapping table is established according to a correspondence between the test case as well as the next test case and the functions. It should be understood that the two test cases in the above embodiment are shown as an example only, and that the software system may include any number of test cases, such as a third test case, a fourth test case, etc., which is not limited herein by the present disclosure.

In some embodiments, a correspondence between corresponding functions and the test cases may be determined according to the correspondence between the test case as well as the next test case and the functions, and the mapping table may be established according to the correspondence between the corresponding functions and the test cases. For example, the correspondence between a test case and a function may be a mapping from test case to function, and the correspondence between a function and a test case may be a mapping from function to test case.

In some embodiments, the test case may be a solid state drive (SSD) replacement test case. Functions associated with the SSD replacement test case may include a function function_detect_ssd_removed for detecting the removal of the SSD, a function function_detect_ssd_inserted for detecting the insertion of the SSD, a function function_detect_ssd_supported_or_not for detecting whether the SSD is supported, and a function function_rebuid_ssd for rebuilding the SSD.

In some embodiments, the test case may be a cable replacement test case. Functions associated with the cable replacement test case may include a function function_detect_cable_removed for detecting the removal of the cable, a function function_detect_cable_inserted for detecting the insertion of the cable, a function function_detect_cable_supported_or_not for detecting whether the cable is supported, and function_tobrng_cable_link_up for causing the cable to establish a link.

In some embodiments, the test case may correspond to the SSD replacement test case, and the next test case may correspond to the cable replacement test case. In this embodiment, the mapping table indicating the correspondence between the functions and the test cases may be listed as follows.

TABLE 1
Mapping table of functions to test cases

| Functions | Test Cases |
|---|---|
| function_detect_ssd_removed | SSD replacement test |
| function_detect_ssd_inserted | SSD replacement test |
| function_detect_ssd_supported_or_not | SSD replacement test |
| function_rebuid_ssd | SSD replacement test |
| function_detect_cable_removed | Cable replacement test |
| function_detect_cable_inserted | Cable replacement test |
| function_detect_cable_supported_or_not | Cable replacement test |
| function_to_bring_cable_link_up | Cable replacement test |

In the above embodiment, when it is determined that the functions involved in the pull request are one or more functions of function_detect_ssd_removed, function_detect_ssd_inserted, function_detect_ssd_supported_or_not, and function_rebuid_ssd, the test cases to be run are determined to include an SSD test according to Table 1. When it is determined that the functions involved in the pull request are one or more functions of function_detect_cable_removed, function_detect_cable_inserted, function_detect_cable_supported_or_not, and function_to_bring_cablelink_up, the test cases to be run are determined to include a cable replacement test according to Table 1. The above functions, test cases, and mapping tables are presented as examples only, and depending on the implementation, different or different numbers of functions, test cases, and mapping tables may be used, which is not limited herein by the present disclosure.

It should be understood that establishing a mapping table for testing a pull request according to the above embodiments makes it possible to run test cases related to functions involved in that pull request without running all the test cases during the testing of the pull request, thus saving time and the amount of computation. Moreover, the various test cases related to that pull request are covered, thus avoiding bugs after code merging due to missing of test cases, thereby improving the efficiency and accuracy of testing.

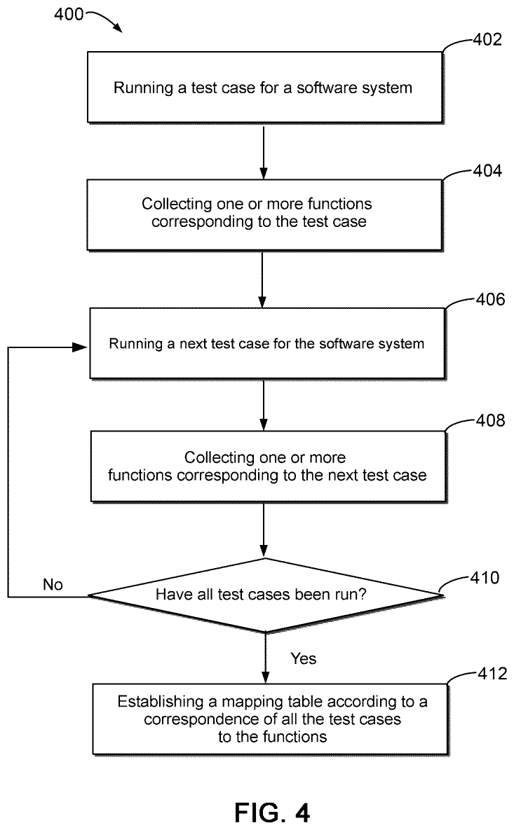

FIG. 4 illustrates a flow chart of another method 400 for establishing a mapping table according to some embodiments of the present disclosure. At 402, a test case for a software system is run, where this test case may also be referred to as a first test case. At 404, one or more functions corresponding to the test case are collected. At 406, a next test case for the software system is run, where this next test case may also be referred to as a second test case. At 408, one or more functions corresponding to the next test case are collected.

In some embodiments, one or more functions corresponding to a corresponding test case may be collected by collecting mappings from test cases to functions via a code coverage tool. For example, the collecting step may be performed via gcov. In some embodiments, the code coverage tool may be used to perform statistics and analysis of the execution of the code in a program to determine which portions of the code have been actually run and which portions of the code may not have been adequately tested, thereby helping the developers better understand the level of test coverage of the code in order to optimize the testing strategy and improve the quality of the code.

At 410, it is determined whether all the test cases for the software system have been run. If yes, at 412, the mapping table is established according to a correspondence between all the test cases and the functions. It should be understood that mappings from functions to test cases can be determined according to the mappings from test cases to functions, and the mappings from functions to test cases can be listed to establish the mapping table.

If no, the process returns to 406 to run the next test case for the software system until it is determined at 410 that all the test cases have been run. For example, if it is no at step 410, a third test case for the software system may be run, and one or more functions corresponding to the third test case may be collected. If it is still no at step 410 for the third test case, a fourth test case for the software system may be run, and one or more functions corresponding to the fourth test case may be collected.

It should be understood that test cases in the system may be run iteratively, and one or more functions corresponding to the test cases may be collected until all test cases for the software system have been run.

It should be understood that in the above embodiments, the first, the second, the third, or the fourth test case is shown only as an example and does not limit the number of test cases included in the software system. The software system may include any number of test cases, for example, thousands or tens of thousands of test cases, which is not limited in the present disclosure.

In some implementations, step 410 may be performed after running each test case for the software system to determine whether all the test cases have been run. In some implementations, step 410 may be performed after running a predetermined number of test cases. For example, it may be determined, after every 2, 10, 100, or 1000 test cases are executed, whether all the test cases have been run. It should be understood that step 410 may be performed at an interval of any number of test cases.

In some embodiments, test cases for the software system may be run iteratively until it is determined that all the test cases for the software system have been run. For example, one or more functions corresponding to a corresponding test case may be determined, and the test cases for the software system may be categorized according to the functions, so as to establish the mapping table.

In some embodiments, one or more functions corresponding to a corresponding test case may be determined in the case where it is determined that all the test cases in the software system have been run, and a next test case for the software system may be run in the case where it is determined that not all the test cases in the software system have been run.

It can be understood that by determining by the method 400 before establishing the mapping table whether all the test cases for the software system have been run, it can be ensured that all the test cases and all the functions of the software system are covered, thereby ensuring the integrity and accuracy of the mapping table, and further improving the accuracy of the testing of the pull request.

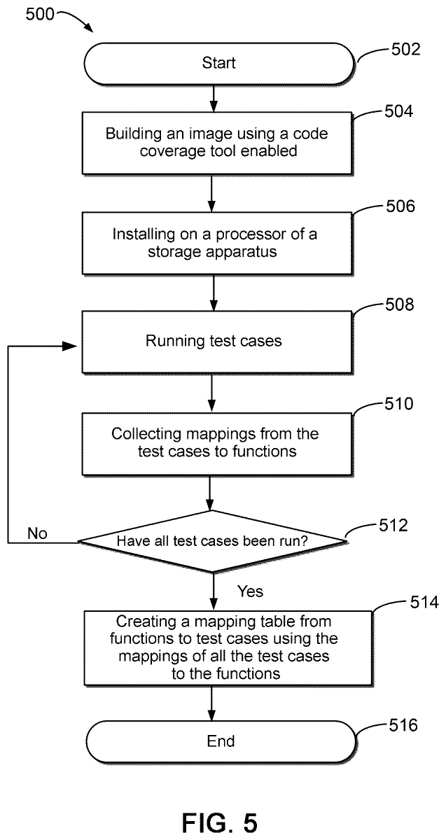

FIG. 5 illustrates a flow chart of a further method 500 for establishing a mapping table according to some embodiments of the present disclosure. At 502, the method 500 is started. At 502, an image or code is built using a code coverage tool enabled. In some embodiments, the code coverage tool may be gcov. For example, by building the mapping, gcov can be integrated with the entire system environment, thus enabling a more comprehensive analysis of the performance of the code in different scenarios, not just in local tests, which facilitates the ready reference and utilization of such coverage information in the follow-up development and maintenance processes.

At 504, the built image is installed on a storage server to run the test case. At 508, a test case for the software system is run. At 510, mappings from test cases to functions are collected. In some embodiments, the test case may include an SSD replacement test and a cable replacement test, and the mappings from test cases to functions may include: SSD replacement tests 4 function_detect_ssd_removed, function_detect_ssd_inserted, function_detect_ssd_supported_or_not, and function_rebuid_ssd; and cable replacement tests 4 function_detect_cable_removed, function_detect_cable_inserted, function_detect_cable_supported_or_not, and function_to_bring_cable_link_up.

At 512, it is determined whether all the test cases have been run. If yes, at 514, a mapping table from functions to test cases is created using mappings from all test cases to functions, and at 516, the method 500 is ended. In some embodiments, the mappings from all test cases to functions may be used to determine a mapping from a corresponding function to a test case, and the mapping from the corresponding function to the test case is shown in the mapping table.

In the above embodiment, the mapping from the corresponding function to the test case may include:
function_detect_ssd_removed→SSD replacement test;
function_detect_ssd_inserted→SSD replacement test;
function_detect_ssd_supported_or_not→SSD replacement test;
function_rebuid_ssd→SSD replacement test;
function_detect_cable_removed→cable replacement test;
function_detect_cable_inserted→cable replacement test;
function_detect_cable_supported_or_not→cable replacement test; and
function_to_bring_cable_link_up→cable replacement test.

For example, a mapping table, for example, Table 1, may be established according to the above mappings. For example, upon detecting that the pull request includes a corresponding function, a test case corresponding to that function may be determined to be run. That is, for the corresponding test case, the code in the pull request is executed.

If the result of step 512 is no, the process returns to 508 to run the next test case for the software system and collect a mapping from the next test case to the function until it is determined at 512 that all the test cases have been run. It should be understood that the functions, test cases, and mappings described above are presented as examples only, and that different functions, test cases, and mappings may be used, which is not limited in the present disclosure.

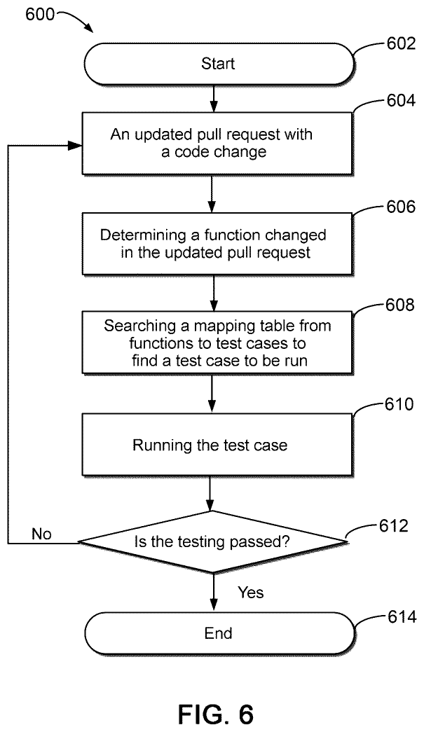

FIG. 6 illustrates a flow chart of another method 600 for testing a pull request according to some embodiments of the present disclosure. At 602, the method 600 is started. At 604, an updated pull request with a code modification or change is acquired. It should be understood that the code change is associated with a function change. At 606, a function changed in the updated pull request is determined. At 608, a mapping table from functions to test cases is searched to find a test case to be run. At 610, the test case determined at 608 is run to test the updated pull request with respect to the relevant test case.

At 612, it is determined whether the updated pull request passes the testing. If yes, at 614, the method 600 is ended, and this updated pull request is merged into the software system. It should be understood that the result at 612 being yes means that for all the test cases determined at 608, this updated pull request will have no negative impact, such as causing the software system to fail to operate or introducing bugs. If no, the process returns to 604 to reacquire a pull request that has been updated again. Specifically, an updated pull request that has not passed the testing can be updated again by the developer for use in testing again. In the embodiment described above, the updated pull request may be referred to as a first pull request, and the pull request updated again may be referred to as a second pull request.

In some embodiments, in the case where the pull request does not pass the testing, the pull request may be prevented from being merged into the software system, the process may wait for a certain amount of time to allow for the provision of feedback by other members for the developer making the pull request to make code modifications, and then it is detected whether there is a next pull request different from that pull request, wherein this next pull request may also be referred to as a second pull request.

In some embodiments, in the case where it is detected that there is a next pull request, one or more functions involved in the next pull request are determined; one or more test cases corresponding to the one or more functions are determined based on the mapping table; and the one or more test cases are run to test the pull request.

In some embodiments, before step 604, it may also be determined whether the pull request has been updated. For example, code before and after the pull request can be compared to determine whether the pull request has been updated; a modified code fragment is acquired in response to the pull request being updated; and according to the modified code fragment, a function changed in the pull request is determined.

In some embodiments, the updated pull request may be a modified version for the previous pull request or may be another pull request different from the previous pull request. Here, the previous pull request may also be referred to as a first pull request, and the updated pull request may also be referred to as a second pull request. It should be understood that the updated pull request and the previous pull request can be committed by the same developer or by different developers.

With the method 600, in the case where the current test case does not pass the testing, the current pull request can be updated, and the updated pull request can be tested until the updated pull request can pass the testing. It should be understood that the methods, processes, and steps described above are presented as examples only, and that different methods, processes, and steps may be used to test a pull request, which is not limited herein by the present disclosure.

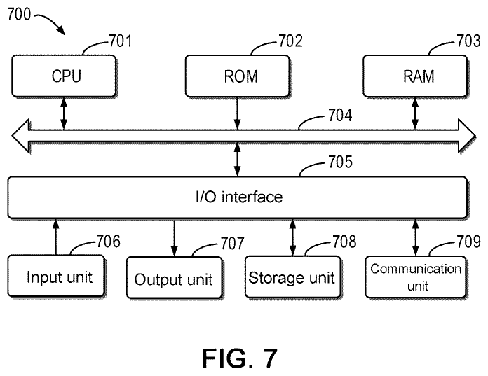

FIG. 7 illustrates a schematic block diagram of an example device 700 which can be used to implement embodiments of the present disclosure. As shown in the figure, the device 700 includes a computing unit 701 that may perform various appropriate actions and processing according to computer program instructions stored in a read-only memory (ROM) 702 or computer program instructions loaded from a storage unit 707 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

A plurality of components in the device 700 are connected to the I/O interface 705, including: an input unit 706, such as a keyboard and a mouse; an output unit 707, such as various types of displays and speakers; a storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processing described above, such as the methods 200-600. For example, in some embodiments, the methods 200-600 may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the methods 200-600 described above may be performed.

Alternatively, in other embodiments, the computing unit 701 may be configured to implement the methods 200-600 in any other suitable manners (such as by means of firmware).

The functions described hereinabove may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof.

Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation.

Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for testing a pull request, comprising:
acquiring a pull request for a software system;
determining one or more functions involved in the pull request;
determining one or more test cases corresponding to the one or more functions based on a mapping table, wherein the mapping table indicates a correspondence between the functions and the test cases; and
running the one or more test cases to test the pull request.

2. The method according to claim 1, further comprising:
running a first test case for the software system;
collecting one or more functions corresponding to the first test case;
running a second test case for the software system;
collecting one or more functions corresponding to the second test case until all test cases for the software system have been run; and
establishing the mapping table according to a correspondence between the first test case as well as the second test case and the functions.

3. The method according to claim 2, wherein establishing the mapping table comprises:
determining a correspondence between corresponding functions and the test cases according to the correspondence between the first test case as well as the second test case and the functions; and
establishing the mapping table according to the correspondence between the corresponding functions and the test cases.

4. The method according to claim 2, wherein establishing the mapping table comprises:
determining, after collecting the one or more functions corresponding to the second test case, whether all the test cases for the software system have been run; and
establishing the mapping table based on a correspondence between all the test cases and functions in the case where it is determined that all the test cases for the software system have been run.

5. The method according to claim 2, further comprising, before running the first test case for the software system:
building an image using a code coverage tool enabled; and
installing the built image on a storage server to run the test case.

6. The method according to claim 1, wherein determining one or more functions involved in the pull request comprises:
comparing code before and after the pull request to determine whether the pull request has been updated;
acquiring a modified code fragment in response to the pull request being updated; and
determining, according to the modified code fragment, a function changed in the pull request.

7. The method according to claim 1, wherein testing the pull request comprises:
in the case where the testing has been passed, merging the pull request into the software system; and
in the case where the testing is not passed, preventing the pull request from being merged into the software system and detecting whether there is a second pull request different from the pull request.

8. The method according to claim 7, wherein detecting whether there is a second pull request different from the pull request comprises: in the case where it is detected that there is the second pull request,
determining one or more functions involved in the second pull request;
determining one or more test cases corresponding to the one or more functions based on the mapping table; and
running the one or more test cases to test the second pull request.

9. The method according to claim 8, further comprising establishing the mapping table by:
running test cases for the software system iteratively until it is determined that all test cases for the software system have been run;
determining one or more functions corresponding to a corresponding test case; and
categorizing the test cases for the software system according to the functions to establish the mapping table.

10. The method according to claim 9, wherein running all test cases for the software system iteratively comprises:
determining one or more functions corresponding to a corresponding test case in the case where it is determined that all the test cases in the software system have been run; and
running a next test case for the software system in the case where it is determined that not all the test cases in the software system have been run.

11. An electronic device, comprising:
at least one processor; and
a memory coupled to the at least one processor and having instructions stored thereon, the instructions, when executed by the at least one processor, causing the electronic device to perform actions which include:
acquiring a pull request for a software system;
determining one or more functions involved in the pull request;
determining one or more test cases corresponding to the one or more functions based on a mapping table, wherein the mapping table indicates a correspondence between the functions and the test cases; and
running the one or more test cases to test the pull request.

12. The electronic device according to claim 11, wherein the actions further comprise:
running a first test case for the software system;
collecting one or more functions corresponding to the first test case;
running a second test case for the software system;
collecting one or more functions corresponding to the second test case until all test cases for the software system have been run; and
determining a correspondence between corresponding functions and the test cases according to the correspondence between the first test case as well as the second test case and the functions; and
establishing the mapping table according to the correspondence between the corresponding functions and the test cases.

13. The electronic device according to claim 12, wherein establishing the mapping table comprises:
determining, after collecting the one or more functions corresponding to the second test case, whether all the test cases for the software system have been run; and
establishing the mapping table based on a correspondence between all the test cases and functions in the case where it is determined that all the test cases for the software system have been run.

14. The electronic device according to claim 12, wherein the actions further comprises, before running the first test case for the software system:
building an image using a code coverage tool enabled; and
installing the built image on a storage server to run the test case.

15. The electronic device according to claim 11, wherein determining one or more functions involved in the pull request comprises:
comparing code before and after the pull request to determine whether the pull request has been updated;
acquiring a modified code fragment in response to the pull request being updated; and
determining, according to the modified code fragment, a function changed in the pull request.

16. The electronic device according to claim 11, wherein testing the pull request comprises:
in the case where the testing has been passed, merging the pull request into the software system; and
in the case where the testing is not passed, preventing the pull request from being merged into the software system and detecting whether there is a second pull request different from the pull request.

17. The electronic device according to claim 16, wherein detecting whether there is a second pull request different from the pull request comprises: in the case where it is detected that there is the second pull request,
determining one or more functions involved in the second pull request;
determining one or more test cases corresponding to the one or more functions based on the mapping table; and
running the one or more test cases to test the second pull request.

18. The electronic device according to claim 17, further comprising establishing the mapping table by:
running test cases for the software system iteratively until it is determined that all test cases for the software system have been run;
determining one or more functions corresponding to a corresponding test case; and
categorizing the test cases for the software system according to the functions to establish the mapping table.

19. The electronic device according to claim 17, wherein running all test cases for the software system iteratively comprises:
determining one or more functions corresponding to a corresponding test case in the case where it is determined that all the test cases in the software system have been run; and
running a next test case for the software system in the case where it is determined that not all the test cases in the software system have been run.

20. A computer program product having a non-transitory computer readable medium which stores a set of instructions to test a pull request; the set of instructions, when carried out by computerized circuitry, causing the computerized circuitry to perform a method of:
acquiring a pull request for a software system;
determining one or more functions involved in the pull request;
determining one or more test cases corresponding to the one or more functions based on a mapping table, wherein the mapping table indicates a correspondence between the functions and the test cases; and
running the one or more test cases to test the pull request.
